(19) United States
(12) Patent Application Publication
(10) Pub. No.: US 2013/0041976 A1
(43) Pub. Date: Feb. 14, 2013

(54) CONTEXT-AWARE DELIVERY OF CONTENT

(71) Applicants: John Hendricks, Seattle, WA (US); Kyle R. Johns, Sammamish, WA (US)

(72) Inventors: John Hendricks, Seattle, WA (US); Kyle R. Johns, Sammamish, WA (US)

(73) Assignee: Microsoft Corporation, Redmond, WA (US)

(21) Appl. No.: 13/208,340

(22) Filed: Aug. 12, 2011

(51) Int. Cl. G06F 15/16

(52) U.S. Cl. 709/217

(57) ABSTRACT

A mobile device such as a robot is provided that includes a processor executing instructions that provide content to a primary user. The robot also includes a software component executed by the processor configured to select the content comprising a potential interest for the primary user associated with the robot. The content is selected based on a previous interaction between the primary user and the robot. The previous interaction is associated with the potential interest. The software component is also configured to provide the content to the primary user in an interaction between the robot and the primary user. The software component is further configured to determine an interest level of the primary user for the potential interest based on the interaction.

### BACKGROUND

Mobile and other computing devices are used for obtaining content, typically, over the Internet. Content may be any information relayed to the user in the form of: messages, audio and visual recordings, multimedia content, etc. Content is derived from a myriad of sources, including application program interfaces (APIs), and feeds, for example. Computing devices retrieve content through APIs to content providers, such as social networks. Feeds, such as really simple syndication (RSS) feeds typically provide news content, specific interests, etc. To receive content to the user's liking, the user typically describes preferences, including ratings on content that has been provided historically. In this way, the user may customize the content delivered. However, having the user manually configure the computing device to deliver such content is time-consuming and tedious.

### SUMMARY

The following is a brief summary of subject matter that is described in greater detail herein. This summary is not intended to be limiting as to the scope of the claims. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The claimed subject matter generally provides a robot that includes a processor executing instructions that deliver content to a primary user. The robot also includes a software component executed by the processor configured to select the content comprising a potential interest for the primary user associated with the robot. The content is selected based on a previous interaction between the primary user and the robot. The previous interaction is associated with the potential interest. The software component is also configured to provide the content to the primary user in an interaction between the robot and the primary user. The software component is further configured to determine an interest level of the primary user for the potential interest based on the interaction.

Another embodiment of the claimed subject matter relates to a mobile device. The mobile device includes a processor, and a software component. The software component is configured to direct the processor to select content comprising a potential interest for the primary user associated with the mobile device. The content is selected based on a previous interaction between the primary user and the mobile device. The previous interaction is associated with the potential interest. The content is provided to the primary user in an interaction between the mobile device and the primary user. An interest level of the primary user for the potential interest is determined based on the interaction. Future content comprising the potential interest is selected based on the interest level.

Yet another embodiment of the claimed subject matter relates to a method for delivering content to a primary user. The method includes selecting content comprising a potential interest for the primary user. The content is selected based on a previous interaction between the primary user and a mobile device. The previous interaction is associated with the potential interest. The method also includes generating an interaction chain comprising the content. The interaction chain comprises a plurality of activities related to the content. The method further includes requesting the primary user engage in the plurality of activities. Additionally, the method includes determining an interest level based on a number of activities that the primary user engages in. Further, the method includes selecting future content comprising the potential interest based on the interest level.

### BRIEF DESCRIPTION OF THE DRAWINGS

FIG. 1 is a block diagram of a robotic device or robot in accordance with the claimed subject matter;

FIG. 2 is a block diagram of an environment that facilitates communications between the robot and one or more remote devices, in accordance with the claimed subject matter;

FIG. 3 is a block diagram of a content management system in accordance with the claimed subject matter; and

FIG. 4 is a process flow diagram of a method of delivering content to a user in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

Electronic devices, including robotic and other mobile devices, are typically unable to deliver rich content that takes into account past experiences, and is tailored to the current situation of the user. Typical systems rely on manual control by a user to setup content feeds, to decide which feeds to access, aggregate, or to decide when feeds are accessed. Additionally, such devices may rely on manual interaction with the user. For example, the user may be asked to label content, such as songs, with a “like” or a “dislike” rating. This rating may impact future song selections to be played for the user. Labeling a song as “liked” may lead to the playing of future songs with the same composer, genre, etc. Such preferences may be maintained in pre-built databases to customize content experiences over time. However, such systems may be unaware of the user's preferences unless specific, manual, action is taken to inform the system.

In one embodiment of the claimed subject matter, an automated content delivery system uses data collected about a user through analytics and online feeds in conjunction with current information about the user and the user's environment to provide unique, customized, content experiences. The system monitors the user's level of interest during content delivery and stores an evaluation of the interaction to tailor future content delivery experiences. The system becomes more robust over time as the system collects data on the user and content delivery experiences. The system may be implemented on various mobile devices, including a robotic device.

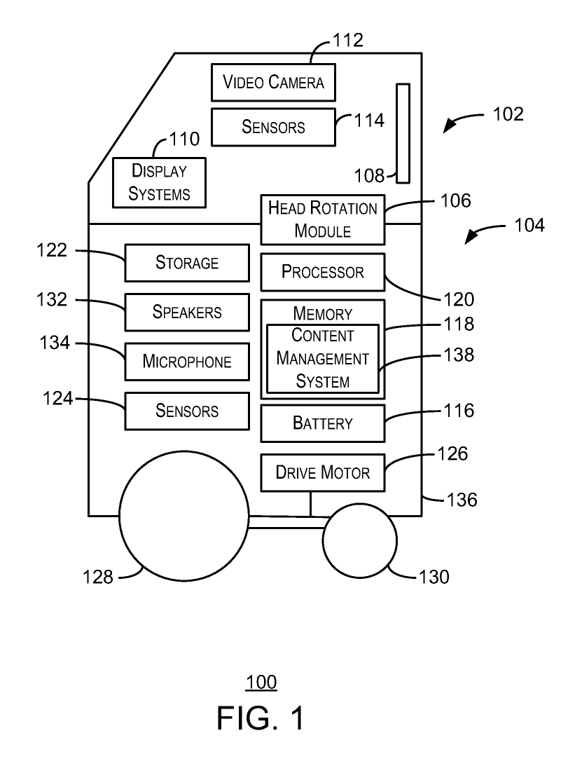

FIG. 1 is a block diagram of a robotic device or robot 100 in accordance with the claimed subject matter. The robot 100 may be capable of communicating with a remotely-located computing device by way of a network connection. The robot 100 is an electro-mechanical machine that includes computer hardware and software that causes the robot 100 to perform functions independently and without assistance from a user. The robot 100 can include a head portion 102 and a body portion 104, wherein the head portion 102 is movable with respect to the body portion 104. Additionally, the robot 100 can include a head rotation module 106 that operates to couple the head portion 102 with the body portion 104, wherein the head rotation module 106 can include one or more motors that can cause the head portion 102 to rotate with respect to the body portion 104. As an example, the head rotation module 106 may rotate the head portion 102 with respect to the body portion 104 up to 45° in any direction. In another example, the head rotation module 106 can allow the head portion 102 to rotate 90° in relation to the body portion 104. In still yet another example, the head rotation module 106 can facilitate 180° rotation of the head portion 102, with respect to the body portion 104. The head rotation module 106 can facilitate rotation of the head portion 102 with respect to the body portion 102 in either angular direction.

The head portion 102 may include an antenna 108 that is configured to receive and transmit wireless signals. For instance, the antenna 108 can be configured to receive and transmit Wi-Fi signals, Bluetooth signals, infrared (IR) signals, sonar signals, radio frequency (RF), signals or other suitable signals. The antenna 108 can be configured to receive and transmit data to and from a cellular tower or a wireless router. The wireless router may provide a connection to a network, such as the Internet. Further, the robot 100 may communicate with a remotely-located computing device (not shown) using the antenna 108.

The head portion 102 of the robot 100 also includes one or more display systems 110 configured to display information to an individual that is proximate to the robot 100. A video camera 112 disposed on the head portion 102 may be configured to capture images and video of an environment of the robot 100. For example, the video camera 112 can be a high definition video camera that facilitates capturing video data that is in, for instance, 720p format, 720i format, 1080p format, 1080i format, or other suitable high definition video format. The video camera 112 may also be configured to capture relatively low resolution data in a format that is suitable for transmission to the remote computing device by way of the antenna 108. As the video camera 112 is mounted in the head portion 102 of the robot 100, through utilization of the head rotation module 106, the video camera 112 can be configured to capture live video data of a relatively large portion of an environment of the robot 100. The video camera 112 may provide red green blue (RGB) data about the environment.

The robot 100 may further include one or more sensors 114. The sensors 114 may include any type of sensor that can aid the robot 100 in performing autonomous or semi-autonomous navigation. For example, these sensors 114 may include a depth sensor, an infrared (IR) sensor, a camera, a cliff sensor that is configured to detect a drop-off in elevation proximate to the robot 100, a GPS sensor, an accelerometer, a gyroscope, or other suitable sensor type. The sensors 114 may also include an infrared (IR) depth sensor. Depth data is typically collected for automatic navigation and gesture detection. However, during low-light and no-light conditions, the depth data may be used to generate images, and video, of the environment. Additionally, such images and video may be enhanced with available RGB data captured by the video camera 112.

The body portion 104 of the robot 100 may include a battery 116 that is operable to provide power to other modules in the robot 100. The battery 116 may be, for instance, a rechargeable battery. In such a case, the robot 100 may include an interface that allows the robot 100 to be coupled to a power source, such that the battery 116 can be recharged.

The body portion 104 of the robot 100 can also include one or more computer-readable storage media, such as memory 118. The memory 118 includes a content management system 138. The content management system 138 may aggregate original content with social network user data and content feeds (i.e., RSS) and deliver the content autonomously to end users based on analytical data, recorded preferences, geographic location, etc. The content management system 138 may use images from the video camera 112 to tailor content to the user. For example, the content management system 138 may identify users through facial recognition software. The content management system 138 may also gauge the user's interest level with provided content, and adjust future content delivery to that user based on the interest level. Data may be collected throughout an interaction between the robot 100 and the user regarding interest level. For example, the acceptance or decline of offered content may be used. The length of an interaction may also be used. Additionally, the interest level of a user's reaction may be determined based on images and sounds captured by the video camera 112 and microphone 134. In one embodiment, the content management system 138 may evaluate body language, facial cues, speech patterns, and speech tone to determine the user's interest level.

A processor 120, such as a microprocessor, may also be included in the body portion 104. As will be described in greater detail below, the memory 118 can include a number of components that are executable by the processor 120, wherein execution of such components facilitates controlling and/or communicating with one or more of the other systems and modules of the robot. The processor 120 can be in communication with the other systems and modules of the robot 100 by way of any suitable interface, such as a bus hosted by a motherboard. In an embodiment, the processor 120 functions as the “brains” of the robot 100. For instance, the processor 120 may be utilized to process data received from a remote computing device as well as other systems and modules of the robot 100 and cause the robot 100 to perform in a manner that is desired by a user of such robot 100. The robot may also include a storage 122, storing data, applications, etc., which may be written to, and from, the memory 118. In one embodiment, the storage 122 may include one or more non-volatile computer-readable media.

The body portion 104 of the robot 100 can further include one or more sensors 124, wherein such sensors 124 can include any suitable sensor that can output data that can be utilized in connection with autonomous or semi-autonomous navigation. For example, the sensors 124 may include sonar sensors, location sensors, infrared sensors, a camera, a cliff sensor, and/or the like. Data that is captured by the sensors 124 and the sensors 114 can be provided to the processor 120, which can process the data and autonomously navigate the robot 100 based at least in part upon the data output.

A drive motor 126 may be disposed in the body portion 104 of the robot 100. The drive motor 126 may be operable to drive wheels 128 and/or 130 of the robot 100. For example, the wheel 128 can be a driving wheel while the wheel 130 can be a steering wheel that can act to pivot to change the orientation of the robot 100. Additionally, each of the wheels 128 and 130 can have a steering mechanism to change the orientation of the robot 100. Alternatively, the robot 100 may include a differential drive (not shown) which steers the robot 100 by moving one wheel 128, 130 forward while the other wheel 128, 130 moves backward. Furthermore, while the drive motor 126 is shown as driving both of the wheels 128 and 130, it is to be understood that the drive motor 126 may drive only one of the wheels 128 or 130 while another drive motor can drive the other of the wheels 128 or 130. Upon receipt of data from the sensors 114 and 124 and/or receipt of commands from the remote computing device (for example, received by way of the antenna 108), the processor 120 can transmit signals to the head rotation module 106 and/or the drive motor 126 to control orientation of the head portion 102 with respect to the body portion 104, and/or to control the orientation and position of the robot 100.

The body portion 104 of the robot 100 can further include speakers 132 and a microphone 134. Data captured by way of the microphone 134 can be transmitted to the remote computing device by way of the antenna 108. Accordingly, a user at the remote computing device can receive a real-time audio/video feed and may experience the environment of the robot 100. The speakers 132 can be employed to output audio data to one or more individuals that are proximate to the robot 100. This audio information can be a multimedia file that is retained in the memory 118 of the robot 100, audio files received by the robot 100 from the remote computing device by way of the antenna 108, real-time audio data from a web-cam or microphone at the remote computing device, etc. The components described above may be enclosed within a robot skin 136.

While the robot 100 has been shown in a particular configuration and with particular modules included therein, it is to be understood that the robot can be configured in a variety of different manners, and these configurations are contemplated and are intended to fall within the scope of the hereto-appended claims. For instance, the head rotation module 106 can be configured with a tilt motor so that the head portion 102 of the robot 100 can tilt in a vertical direction. Alternatively, the robot 100 may not include two separate portions, but may include a single unified body, wherein the robot body can be turned to allow the capture of video data by way of the video camera 112. In still yet another embodiment, the robot 100 can have a unified body structure, but the video camera 112 can have a motor, such as a servomotor, associated therewith that allows the video camera 112 to alter position to obtain different views of an environment. Modules that are shown to be in the body portion 104 can be placed in the head portion 102 of the robot 100, and vice versa. It is also to be understood that the robot 100 has been provided solely for the purposes of explanation and is not intended to be limiting as to the scope of the hereto-appended claims.

It is noted that embodiments of the claimed subject matter may include the robot 100 or another mobile device. Another mobile device may share many of the same components as the robot 100, such as the memory 118, processor 120, video camera 112, microphone 134, and the content management system 138.

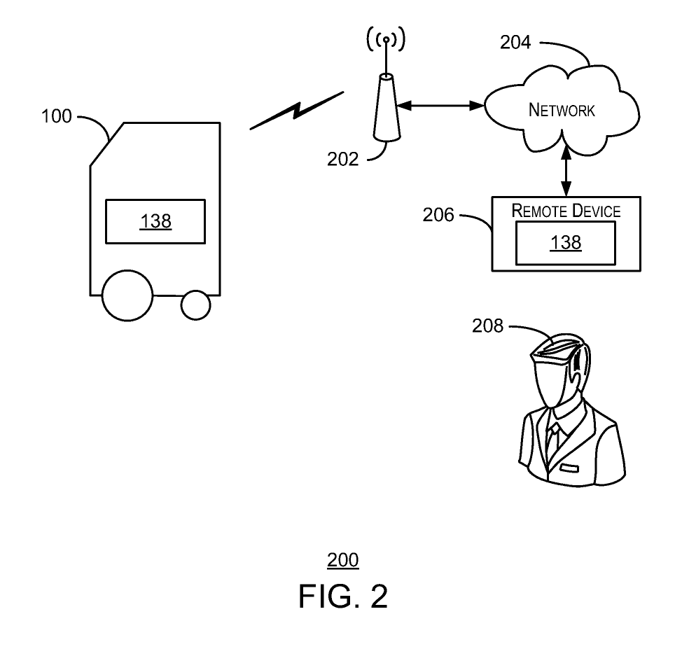

FIG. 2 is a block diagram of an environment 200 that facilitates communication between the robot 100 and one or more remote devices 206, in accordance with the claimed subject matter. More particularly, the environment 200 includes a wireless access point 202, a network 204, and the remote devices 206. The robot 100 is configured to receive and transmit data wirelessly via antenna 108. In an exemplary embodiment, the robot 100 initializes on power up and communicates with a wireless access point 202 and establishes its presence with the access point 202. The robot 100 may then obtain a connection to one or more networks 204 by way of the access point 202. For example, the networks 204 may include a cellular network, the Internet, a proprietary network such as an intranet, or other suitable network.

Each of the remote devices 206 can have respective applications executing thereon that facilitate communication with the robot 100 by way of the network 204. For example, and as will be understood by one of ordinary skill in the art, a communication channel can be established between the remote device 206 and the robot 100 by way of the network 204 through various actions such as handshaking, authentication, and other similar methods. The remote devices 206 may include a laptop computer, a mobile telephone or smart phone, a mobile multimedia device, a gaming console, another robot, or other suitable mobile devices. The remote devices 206 can include or have associated therewith a display or touch screen (not shown) that can present data, images, and other content to various users 208. The robot 100 and remote devices 206 may include content management systems 138 to provide content to particular users 208. Further, the robot 100 and remote devices 206 may share analytical data about particular users 208, such as preferences expressed on social networking sites that indicate a user's interests. The analytical data may also include results of past interactions with users 208. This may include the number of times that a user 208 has accepted offered content, the type of content that was accepted, the number of times that the user has refused offered content, the type of content that was refused. Analytics can also be gathered through direct observation through the video camera 112, and sensors 114, 124. Observations may include a user's facial expressions, overall motion, skeletal tracking to gauge posture, sounds such as laughter, etc. Thermal images and advanced speech analysis may also be used.

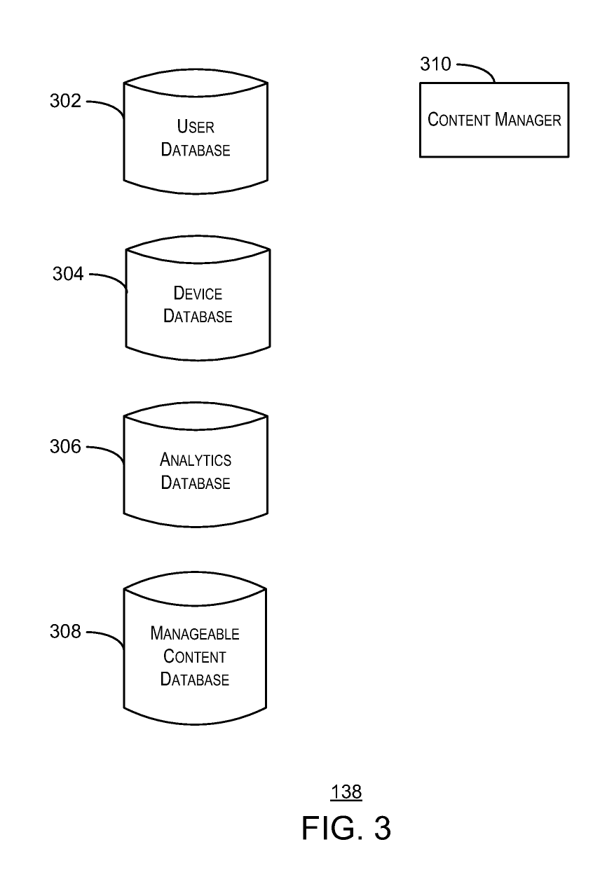

FIG. 3 is a block diagram of the content management system 138 in accordance with the claimed subject matter. As shown, the content management system 138 includes a user database 302, device database 304, analytics database 306, manageable content database 308, and a content manager 310. The user database 302 may include information about users, such as how to identify the user, and how to access information about the user relevant to content selection. For example, the user database 302 may include users' facial images, and access information to users' social network accounts. The facial images may enable the robot to recognize a user for content delivery. Access information may enable the system 138 to identify potential areas of interest for the user, and access content from social networks. The device database 304 includes information about the device, e.g., the robot 100. The device database 304 may include basic parameters for content delivery, such as times when content delivery is permitted. For example, the user may specify that no content is delivered between 11 p.m. and 9 a.m., so the user's sleep is not interrupted. The device database 304 may also specify the results of previous interactions with each user. These results may include the time and location of each interaction, whether the user accepted the offered information or refused, and the type of information offered. The analytics database 306 may include user reactions to delivered content. Interest levels may be determined based on data stored in the analytics database 306. Content, delivered to the user, may be selected based on the interest levels. The manageable content database 308 may include customized and syndicated content.

The content manager 310 may collect user analytics, user feedback, environmental conditions, timing, location, etc., all of which may be taken into consideration regarding the user's interest level in available content. The content manager 310 may add original content to the manageable content database 308, using metatags. The metatags may associate the content with areas of potential interest for the user. The content manager 310 may also import content feeds to the manageable content database 308 using API's or RSS feeds.

The content manager 310 may also create interaction chains around content so that more advanced interactions can be created than are typically capable under fully automated systems. An interaction chain is made up of engagement offers. An example would be where the robot 100 delivers an information update that a user's high score on a video game has been beaten by an opponent player. The interaction chain for this notification may included an offer to launch the game application. If the user decides to play the game and regains the high score the robot 100 may suggest posting a challenge back to the opponent, and facilitate delivery of that challenge. The interaction chain may also include behaviors for alternate outcomes such as the user declining to play, the user playing and not beating the high score, etc. These chains may be created so that they are dependant on multiple conditions such as favorite sports team, age, location, past application use, etc. in such a way that they could be both flexible and exclusive in nature. To evaluate, and potentially automate, content chains the content manager 310 may analyze various state combinations to provide an acceptable probability of success across the user base. The content manager 310 may run automated probability simulations to optimize interaction chains. In this way, the interaction chain is optimized for the user's experience. Interaction chains may be created for various users of the robot 100. As such, the content manager 310 may also prioritize content. Priorities may be based on the aggregated relevance of the device users, local users, and system wide users. Priorities may also be set manually by end-users using a local interface adopted from syndicated feeds. Alternatively, priorities may be set by content managers who administer the manageable content database 308.

An example scenario is provided with the robot 100 interacting with two users: Steve, and Cathy. The content management system 138 may have access to an API for Steve's social networking page. Through the API, the content management system 138 determines that Steve is interested in the Chicago Bears. Through an RSS feed, the content management system 138 finds a news story about the Chicago Bears making it into the playoffs, and decide to offer this content to Steve based on his interest. The user's interest may not be as specific as a note on a social networking page. Content may be offered based on a possible interest. For example, Steve's possible interest in the Bears could be based on past interactions with the robot 100, or, the fact that Steve lives near Chicago. Based on this possible interest, the robot 100 may seek out Steve to give him the news about his team. The robot 100 may use analytics about Steve's location during certain times of the day to locate Steve.

Before encountering Steve, the robot 100 may provide content based on Steve's interest. For example, the display systems 110 may show the Chicago Bears logo. The team's fight song, “Bear Down, Chicago Bears!” may be played over the speakers 132. Before encountering Steve, the robot 100 may encounter Cathy. The robot 100 may seek out Steve through Cathy. Alternatively, the robot 100 may offer the news to Cathy, who may or may not be interested in the Bears. In another scenario, the robot 100 may invite Cathy to contribute to the content delivered to Steve. For example, the robot 100 could ask Cathy to record a video message to Steve, sharing the good news with him. Cathy's level of interaction with the robot 100 regarding this content may represent her interest level for content related to the Bears. Her level of interest may be considered when future content selections are made for Cathy. If Cathy is not interested in the Bears, the robot 100 may offer to tell Cathy a joke. Her interest in the joke may also be recorded and considered for future content selection.

When the robot 100 encounters Steve, the robot 100 may deliver the news about the Bears, possibly using Cathy's recorded message. The robot 100 may also offer further interactions related to the content. For example, the robot 100 could encourage Steve to have a party, at which photos could be taken and shared over his social networking page. The level of Steve's interest may be determined based on the amount of interaction Steve has with the robot 100 related to the Bears' content.

At each stage in the scenario, the robot 100 is using data it has collected to present a compelling content experience. In the first stage of the scenario, the robot 100 has used analytics to decide where to search for Steve based on previous interactions. Finding a non-primary user (Cathy) for the high-priority content item, the robot 100 provides an alternate content chain based around inviting the non-primary user to share in, and add to the high-priority content delivery.

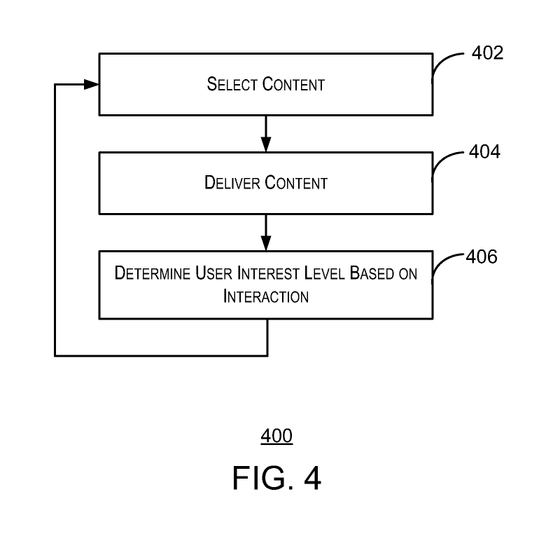

FIG. 4 is a process flow diagram of a method 400 of delivering content to a user in accordance with the claimed subject matter. The method 400 may be performed by the content management system 138 during a series of interactions between the robot 100 and one or more users associated with the robot 100. At block 402, the content management system 138 may select content for an associated user. The content may be selected based on potential interests for the user, and the user's level of interest based on previous interactions with the user. Content may be selected that is related to a number of potential interests for the users of the robot 100.

At block 404, the content management system 138 may deliver the content to the user. The content may include an interaction chain, enabling the user to engage in a number of activities related to the content.

At block 406, the content management system 138 may determine the user's interest level based on the interaction. The user's interest level may be determined based on facial cues, verbal cues, etc. Further, the amount of interaction between the user and the content management system may be used to determine interest level. Flow may return to block 402, where future content may be selected based on the user's interest level.

While the systems, methods and flow diagram described above have been described with respect to robots, it is to be understood that various other devices that utilize or include display technology can utilize aspects described herein. For instance, various industrial equipment, automobile displays, and the like may apply the inventive concepts disclosed herein.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

What is claimed is:

1. A robot, comprising:
a processor executing instructions that provide content to a primary user, the processor issuing control signals corresponding to the content to be provided; and
a software component executed by the processor configured to:
select the content comprising a potential interest for the primary user associated with the robot, wherein the content is selected based on a previous interaction between the primary user and the robot, wherein the previous interaction is associated with the potential interest;
provide the content to the primary user in an interaction between the robot and the primary user; and
determine an interest level of the primary user for the potential interest based on the interaction.

2. The robot of claim 1, wherein the software component is configured to:
generate an interaction chain comprising the content, wherein the interaction chain comprises a plurality of activities related to the content;
request the primary user engage in the plurality of activities; and
determine the interest level based on a number of activities that the user engages in.

3. The robot of claim 2, wherein the software component is configured to:
determine that a current user is not the primary user;
request the current user add an activity to the interaction chain; and
determine an interest level for the current user and the potential interest based on whether the current user adds an activity to the interaction chain.

4. The robot of claim 1, wherein the wherein the software component is configured to select future content comprising the potential interest based on the interest level.

5. The robot of claim 1, wherein the software component is configured to determine the potential interest using an application programming interface (API) to a social network of the primary user.

6. The robot of claim 1, comprising a video camera, wherein one or more images captured by the video camera comprise analytics associated with the interest level.

7. The robot of claim 6, wherein the analytics comprise facial cues of the primary user in response to providing the content.

8. The robot of claim 6, wherein the robot identifies the primary user based on facial recognition performed on an image of the primary user captured by the video camera.

9. The robot of claim 1, wherein the robot shares analytics about the primary user with a remote device.

10. A mobile device, comprising:
a processor;
a software component executable by the processor, the software component configured to direct the processor to:
select content comprising a potential interest for the primary user associated with the mobile device, wherein the content is selected based on a previous interaction between the primary user and the mobile device, wherein the previous interaction is associated with the potential interest;
provide the content to the primary user in an interaction between the mobile device and the primary user;
determine an interest level of the primary user for the potential interest based on the interaction; and
select future content comprising the potential interest based on the interest level.

11. The mobile device of claim 10, wherein the software component is configured to direct the processor to:
generate an interaction chain comprising the content, wherein the interaction chain comprises a plurality of activities related to the content;
request the primary user engage in the plurality of activities; and
determine the interest level based on a number of activities that the user engages in.

12. The mobile device of claim 10, wherein the software component is configured to direct the processor to:
determine that a current user is not the primary user;
request the current user add an activity to the interaction chain; and
determine an interest level for the current user and the potential interest based on whether the current user adds an activity to the interaction chain.

13. The mobile device of claim 10, wherein the software component is configured to direct the processor to determine the potential interest using an application programming interface (API) to a social network of the primary user.

14. The mobile device of claim 10, comprising a video camera, wherein one or more images captured by the video camera comprise analytics associated with the interest level.

15. The mobile device of claim 14, wherein the analytics comprise facial cues of the primary user in response to providing the content.

16. The mobile device of claim 14, wherein the mobile device identifies the primary user based on facial recognition performed on an image of the primary user captured by the video camera.

17. The mobile device of claim 10, wherein the mobile device shares analytics about the primary user with a remote device.

18. A method for providing content to a primary user, comprising:
selecting content comprising a potential interest for the primary user, wherein the content is selected based on a previous interaction between the primary user and a mobile device, wherein the previous interaction is associated with the potential interest;
generating an interaction chain comprising the content, wherein the interaction chain comprises a plurality of activities related to the content;
requesting the primary user engage in the plurality of activities; and
determining an interest level based on a number of activities that the primary user engages in; and
selecting future content comprising the potential interest based on the interest level.

19. The method of claim 18, comprising determining the potential interest using an application programming interface (API) to a social network of the primary user.

20. The method of claim 19, comprising:
determining that the primary user is not interested in the content;
selecting alternate content comprising an alternate potential interest, using the API to the social network;
generating an alternate interaction chain comprising a plurality of activities related to the alternate content;
requesting the user engage in the plurality of activities related to the alternate content;
determining an interest level in the alternate potential interest based on a number of activities related to the alternate content that the primary user engages in; and
selecting future content for the alternate potential interest based on the interest level.
